(19) United States
(12) Patent Application Publication
(10) Pub. No.: US 2025/0173725 A1
(43) Pub. Date: May 29, 2025

(54) MACHINE LEARNING MODEL FOR ANOMALY DETECTION IN DIGITAL ENVIRONMENTS

(71) Applicant: The Toronto-Dominion Bank, Toronto (CA)

(72) Inventors: BHARATHVAJ DEVARAJAN, Ontario (CA); Sagar Purkayastha, Calgary (CA); Wenjia Zhu, Ontario (CA)

(21) Appl. No.: 18/520,529

(22) Filed: Nov. 27, 2023

(51) Int. Cl. G06Q 20/40

(52) U.S. Cl. CPC G06Q 20/4016

(57) ABSTRACT

An example method includes for each training iteration in a series of training iterations: receiving, for a first set of unlabeled metrics data, a set of respective labels associated with an account in a set of accounts. The first set of unlabeled metrics data and a second set of unlabeled metrics data can be processed to generate network inputs representing a respective account in the set of accounts. The network inputs can be processed using a teacher neural network that generates an anomaly prediction output for each network input. A student neural network can be trained to optimize a loss function, which can include minimizing a loss term measuring a difference between the anomaly prediction output and the student network's proposed anomaly prediction output and minimizing a loss term measuring a difference between the proposed anomaly prediction output and the account's associated label.

### TECHNICAL FIELD

The present disclosure relates to computer-implemented methods, software, and systems for using and training a machine learning model to perform anomaly detection in digital environments.

### BACKGROUND

Anomalies are deviations from a norm (e.g., a normal mode of operation). In digital environments, systems are designed to perform in a certain manner and deviations from this normal mode of operation would be considered an anomaly. For example, an anomaly occurs when a digital account corresponding to a user in a digital environment has activity that deviates from the normal mode of operation (or the normal scope of operations for that account). As another example, in the context of computer networks, an anomaly can be a deviation from a normal mode of operation (i.e., normal network activity). When one or more anomalies are detected in a particular digital environment, this can indicate system error or suspicious activity that needs to be investigated. These anomalies can be examined in further detail as they are different from an established pattern of behavior. Anomaly detection systems can automatically detect potentially harmful outliers for a particular application in a digital environment.

### SUMMARY

The present disclosure generally relates to systems, software, and computer-implemented methods for training and using machine learning models to perform anomaly detection in digital environments.

A first example method includes receiving unlabeled metrics data relating to a set of accounts and receiving, for a first set of unlabeled metrics data, a set of respective labels, wherein each label is associated with an account in the set of accounts. The first set of unlabeled metrics data that is associated with the received set of labels and a second set of unlabeled metrics data can be processed to generate a set of network inputs, wherein each network input represents a respective account in the set of accounts. The set of network inputs can be processed using a trained teacher neural network that generates a respective initial anomaly prediction output for each network input. A student neural network can be trained to optimize a loss function, wherein the student neural network processes the set of network inputs and generates a respective proposed anomaly prediction output for each network input. Optimizing the loss function comprises, for each account in the set of accounts: minimizing a loss term that measures a difference between the initial anomaly prediction output of the teacher neural network and the proposed anomaly prediction output of the student neural network when the set of respective labels does not include a label associated with the account; and minimizing a loss term that measures a difference between the proposed anomaly prediction output of the student neural network and the label associated with the account when the set of respective labels includes a label associated with the account.

Implementations can optionally include one or more of the following features.

In some implementations, the student neural network and the teacher neural network have a same architecture. In some examples, the trained teacher neural network in a particular training iteration is the student neural network from a training iteration prior to the particular training iteration. In some instances, receiving the set of respective labels associated with a subset of the set of metrics data representing the set of accounts includes evaluating the accuracy of proposed anomaly detection outputs from the student neural network from a previous training iteration to generate a top subset of proposed anomaly detection outputs and actively querying human experts to label the top subset of proposed anomaly detection outputs.

In some implementations, the loss term that measures a difference between the initial anomaly prediction output of the teacher neural network and the proposed anomaly prediction output of the student neural network is a mean squared error.

In some implementations, the loss term that measures a difference between the proposed anomaly prediction output of the student neural network and the label associated with the account is a cross-entropy loss.

In some implementations, the teacher neural network implements an Isolation Forest anomaly detection algorithm.

Similar operations and processes associated with each example system may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, the techniques described herein utilize a supervised machine learning-based technique to improve the accuracy of traditional unsupervised learning methods for training an anomaly detection model and performing anomaly detection using such a model. This combination of supervised and unsupervised methods results in a semi-supervised approach that works with limited available labels to improve model performance. Solutions that may use unsupervised machine learning algorithms generally suffer from a lack of sufficient digital data to adequately train the model and perform meaningful and accurate anomaly detection. Indeed, such unsupervised models require building up large volume of data (which consumes significant amount of time and computing resources) before the model can be trained and achieve performant results. The techniques described herein enable an anomaly detection model—which can be implemented as a supervised model—to correctly identify anomalies at a higher rate than achievable using only unsupervised training approach, and achieve such relatively higher accuracy while being trained on relatively less data (and requiring fewer computing resources and a relatively lighter weight model). The techniques described herein enable deployment of a high accuracy anomaly detection model that routinely uses a feedback-based implementation to monitor the model accuracy and make improvements thereto, e.g., in an online setting. In particular, and in some implementations, the model deployment here can apply and compute model accuracy metrics and use the computed metrics to make real-time adjustments to the model.

In this manner, the techniques described herein enable an anomaly detection system to use an active learning framework to generate a likelihood that a particular digital asset (e.g., a user account, a network environment) contains an anomaly by implementing resource efficient techniques to utilize a subset of labelled training examples during training of an anomaly prediction system. In general, training an unsupervised anomaly detection system with only unlabeled data can be a computing resource intensive task. In contrast, the techniques described herein utilize unlabeled data as well as human labelled data to identify those features that have a high contribution (or are expected to have a high contribution) to the model's output. Unlike conventional solutions that do not have enough training data to converge in a timely or resource efficient manner, the techniques described herein achieve relative computational efficiencies by also providing the system with labelled data points using an adaptive learning framework—which in turn would converge sooner. An adaptive learning framework allows a model to learn continuously from real-time and variable data. An adaptive learning framework can quickly adapt to new information and continuously processes new, more relevant data, allowing the model to converge more quickly. An adaptive learning framework can also help a model learn from the past and avoid making similar mistakes further in the training process. This allows for less time and computing resource spent during training because, instead of using random initialization, training data can be initialized using the labelled data.

Moreover, the anomaly prediction system's output is dynamic and actionable at any time point—e.g., even at an initial information request phase—where the amount of information and data available to make a decision is relatively less than that which may be available at a later stage. For example, the anomaly prediction system can perform anomaly detection at any point in the lifecycle of transactions or interactions in a particular context of a digital asset e.g., immediately after the creation of a digital asset, two months after the creation of a digital asset, every time a handler of the digital asset changes etc. As a particular example, the anomaly detection system's output can identify an anomaly in a digital account immediately after the creation of the digital account, and prompt further investigation of the account by a human expert.

### DESCRIPTION OF DRAWINGS

FIG. 1 is a block diagram of an example networked environment that trains a machine learning model to perform anomaly detection.

FIG. 2 illustrates an example anomaly detection system that is configured to train a machine learning model to perform anomaly detection in a networked environment, such as the networked environment 100.

FIG. 3 shows an example of training a machine learning model to perform anomaly detection.

FIG. 4 is a flow diagram of an example method for training an anomaly prediction model

### DETAILED DESCRIPTION

The present disclosure describes various tools and techniques associated with training and using a machine learning model to perform anomaly detection in digital environments.

The techniques described herein describe using supervised and unsupervised machine learning models that are trained together and that facilitate faster and more resource efficient training compared to solutions that may only use unsupervised modeling approaches. Indeed, fully unsupervised modeling approach suffers from multiple deficiencies including, e.g., lack of a sufficient amount of training data and training an unsupervised anomaly detection model with only unlabeled data can be a computing resource intensive task.

In contrast, the techniques described herein enable increased computational and network resource efficiency by implementing resource efficient techniques to utilize a subset of labelled training examples during training of the anomaly detection system. In some implementations, the techniques described herein utilize a supervised machine learning-based technique to enhance unsupervised learning methods for training an anomaly detection system. The anomaly detection model can determine if there is anomaly present in a particular context (e.g., in a user account or a network environment).

At a high level (and as described in additional detail throughout this specification), the techniques described here train an anomaly detection system by (1) receiving both labelled and unlabeled training data regarding multiple digital assets (e.g., network accounts, user accounts, etc.), (2) generating an initial prediction on whether each digital asset contains an anomaly based on a previously trained model, and (3) generating a proposed prediction on whether each digital asset contains an anomaly for each using a new model. The new model is trained to minimize the difference between the initial prediction and proposed prediction for digital assets that are unlabeled and to minimize the difference between the label for the digital asset and proposed prediction for digital assets that are labelled.

Additionally, the above-described anomaly detection system can use an active learning framework to generate an indication on whether a particular digital asset contains an anomaly by implementing resource efficient techniques to utilize a subset of labelled training examples during training of an anomaly prediction system. In general, training an anomaly prediction system with only unlabeled data can be a computing resource intensive task. In contrast, the techniques described herein utilize unlabeled data as well as human-labelled data to identify those features that have a high contribution (or are expected to have a high contribution) to the anomaly prediction system's output. Unlike conventional solutions that generally lack sufficient training data to converge in a timely (or resource efficient) manner, the techniques described herein achieve relative computation efficiencies by implementing a student-teacher network with labelled data points using an adaptive learning framework-which in turn results in the network converging relatively sooner (and in that regard, consuming fewer computing resources to achieve such convergence). This allows for less time spent training because, instead of using random initialization, training data can be initialized using the labelled data. An adaptive learning framework allows a model to learn continuously from real-time and variable data. An adaptive learning framework can quickly adapt to new information and continuously processes new, more relevant data, allowing the model to converge more quickly.

Additionally, as described above, the techniques described herein utilize a supervised machine learning-based technique to improve the accuracy of traditional unsupervised learning methods for training an anomaly detection model. The described training method can cause the anomaly detection model to correctly identify anomalies at a higher rate than conventional methods. Training the model on labelled data from previous training iterations can also help a model learn from the past and avoid making similar mistakes further in the training process. The techniques described herein enable deployment of a high accuracy anomaly detection model that routinely uses a feedback-based implementation to monitor the model accuracy and make improvements thereto, e.g., in an online setting. In particular, and in some implementations, the model deployment here can apply and compute model accuracy metrics and use the computed metrics to make real-time adjustments to the model.

As yet another example, the anomaly prediction system's output is dynamic and actionable at any time point—e.g., even at an earlier phase in the activity related to the digital asset (e.g., in the context of a user account, at an initial information request phase) where the amount of information and data available to make a decision is relatively less than that which may be available at a later stage in the lifecycle of the digital asset.

The techniques described herein can be used in the context of anomaly prediction for any digital asset (e.g., accounts, network objects, etc.) and in particular, enable accurate detection of anomalies in the digital assets. One skilled in the art will appreciate that the above described techniques can be applicable in the context of any digital asset (irrespective of type of digital asset).

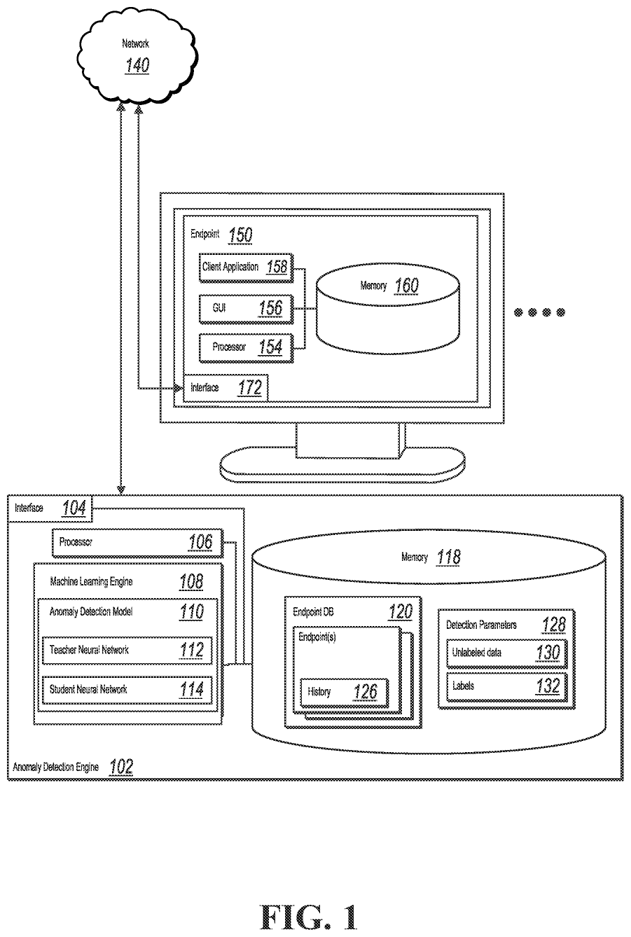

For brevity and ease of description FIGS. 1-4 describe solutions in the context of anomaly detection in accounts for users at particular institutions, but the same techniques are applicable with respect to any other type of digital assets.

Turning to the illustrated example implementation, FIG. 1 is a block diagram illustrating an example networked environment 100 that trains and uses a machine learning model to perform anomaly detection in the networked environment. As further described with reference to FIG. 1, the environment implements supervised machine learning techniques to enhance unsupervised learning solutions for training an anomaly detection model.

As shown in FIG. 1, the example environment 100 includes an anomaly detection engine 102 and multiple endpoints 150 that are interconnected over a network 140. The function and operation of each of these components is described below.

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In some implementations, the illustrated implementation is directed to techniques whereby the anomaly detection engine 102 can indicate if a digital asset deviates from a norm or normal mode of operation. The anomaly detection engine 102 can identify, for a particular digital asset, using an anomaly detection model 110, whether the particular digital asset includes an anomaly or does not include anomalies.

As illustrated, the anomaly detection engine 102 includes or is associated with a machine learning engine 108. The machine learning engine 108 may be any application, program, other component, or combination thereof that, when executed by the processor 106, enables the detection of an anomaly in an account.

As illustrated, the machine learning engine 108 can include an anomaly detection model 110, one or more teacher neural networks 112, and one or more student neural networks 114—each of which can include or specify programmable instructions for generating an initial anomaly prediction output, and a proposed anomaly prediction output, respectively. For an endpoint 150, the anomaly detection model 110 can compute a likelihood that an digital asset includes an anomaly. The one or more teacher neural networks 112 can compute, for the endpoint 150 and for a particular digital asset, an initial anomaly prediction output e.g., a likelihood that the digital asset includes an anomaly. The one or more student neural networks 114 can compute, for the endpoint 150 and for a particular digital asset, a proposed anomaly prediction output. Additional details about the function and structure of these models are provided throughout this specification.

As described above, and in general, the environment 100 enables the illustrated components to share and communicate information across devices and systems (e.g. anomaly detection engine 102, endpoint 150, among others) via network 140. As described herein, the anomaly detection engine 102 and/or the endpoint 150 may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server. Conversely, functionality that is shown or described as being performed by one component, may be performed and/or provided by two or more components, systems, or servers.

As used in the present disclosure, the term “computer” is intended to encompass any suitable processing device. For example, the anomaly detection engine 102, and/or the endpoint 150 may be any computer or processing devices such as, for example, a blade server, general-purpose personal computer (PC), Mac®, workstation, UNIX-based workstation, or any other suitable device. Moreover, although FIG. 1 illustrates a single anomaly detection engine 102, the anomaly detection engine 102 can be implemented using a single system or more than those illustrated, as well as computers other than servers, including a server pool. In other words, the present disclosure contemplates computers other than general-purpose computers, as well as computers without conventional operating systems.

Similarly, the endpoint 150 may be any system that can request data and/or interact with the anomaly detection engine 102. The endpoint 150, also referred to as client device 150, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The endpoint 150 may include one or more merchant- or financial institution-specific applications executing on the endpoint 150, or the endpoint 150 may include one or more Web browsers or web applications that can interact with particular applications executing remotely from the endpoint 150, such as the machine learning engine 108, among others.

As illustrated, the anomaly detection engine 102 includes or is associated with interface 104, processor(s) 106, machine learning engine 108, and memory 118. While illustrated as provided by or included in the anomaly detection engine 102, parts of the illustrated components/functionality of the anomaly detection engine 102 may be separate or remote from the anomaly detection engine 102, or the anomaly detection engine 102 may itself be distributed across the network 140.

The interface 104 of the anomaly detection engine 102 is used by the anomaly detection engine 102 for communicating with other systems in a distributed environment—including within the environment 100—connected to the network 140, e.g., the endpoint 150, and other systems communicably coupled to the illustrated anomaly detection engine 102 and/or network 140. Generally, the interface 104 comprises logic encoded in software and/or hardware in a suitable combination and operable to communicate with the network 140 and other components. More specifically, the interface 104 can comprise software supporting one or more communication protocols associated with communications such that the network 140 and/or interface's hardware is operable to communicate physical signals within and outside of the illustrated environment 100. Still further, the interface 104 can allow the anomaly detection engine 102 to communicate with the endpoint 150, and/or other portions illustrated within the anomaly detection engine 102 to perform the operations described herein.

The anomaly detection engine 102, as illustrated, includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the anomaly detection engine 102. Specifically, the processor 106 executes the algorithms and operations described in the illustrated figures, as well as the various software modules and functionality, including the functionality for sending communications to and receiving transmissions from the endpoint 150, as well as to other devices and systems. Each processor 106 may have a single or multiple core, with each core available to host and execute an individual processing thread. Further, the number of, types of, and particular processors 106 used to execute the operations described herein may be dynamically determined based on a number of requests, interactions, and operations associated with the risk assessment engine 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including, e.g., C, C++, JavaScript, Java™, Visual Basic, assembler, Perl®, any suitable version of 4GL, as well as others.

The anomaly detection engine 102 can include, among other components, one or more applications, entities, programs, agents, or other software or similar components configured to perform the operations described herein.

The anomaly detection engine 102 also includes memory 118, which may represent a single memory or multiple memories. The memory 118 may include any memory or database module and may take the form of volatile or non-volatile memory including, without limitation, magnetic media, optical media, random access memory (RAM), read-only memory (ROM), removable media, or any other suitable local or remote memory component. The memory 118 may store various objects or data associated with anomaly detection engine 102, including any parameters, variables, algorithms, instructions, rules, constraints, or references thereto. While illustrated within the anomaly detection engine 102, memory 118 or any portion thereof, including some or all of the particular illustrated components, may be located remote from the anomaly detection engine 102 in some instances, including as a cloud application or repository, or as a separate cloud application or repository when the anomaly detection engine 102 itself is a cloud-based system. As illustrated, memory 118 includes an endpoint database 120 (also referred to as endpoint DB 120). The endpoint database 120 can store various data associated with endpoint(s), including each endpoint's history 126. The history 126 of an endpoint can include, among other things, previously computed anomaly detection outputs for the particular endpoint. The anomaly detection outputs can be, for example, a label e.g., “Anomaly” or “Not Anomaly”. As another example, the anomaly detection outputs can be a likelihood that an account is anomalous or includes anomalous activity.

Network 140 facilitates wireless or wireline communications between the components of the environment 100 (e.g., between the anomaly detection engine 102 and the endpoint 150, etc.), as well as with any other local or remote computers, such as additional mobile devices, clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., the anomaly detection engine 102, the endpoint 150, etc.) may be included within or deployed to network 140 or a portion thereof as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated, one or more endpoints 150 may be present in the example environment 100. Although FIG. 1 illustrates a single endpoint 150, multiple endpoints may be deployed and in use according to the particular needs, desires, or particular implementations of the environment 100. Each endpoint 150 may be associated with a particular user (e.g., an employee or a customer of a financial institution), or may be accessed by multiple users, where a particular user is associated with a current session or interaction at the endpoint 150. Endpoint 150 may be a client device at which the user is linked or associated, or a client device through which the user interacts with anomaly detection engine 102 and its machine learning engine 108. As illustrated, the endpoint 150 may include an interface 152 for communication (which may be operationally and/or structurally similar to interface 104), at least one processor 154 (which may be operationally and/or structurally similar to processor 106), a graphical user interface (GUI) 156, a client application 158, and a memory 160 (similar to or different from memory 118) storing information associated with the endpoint 150.

The illustrated endpoint 150 is intended to encompass any computing device such as a desktop computer, laptop/notebook computer, mobile device, smartphone, personal data assistant (PDA), tablet computing device, one or more processors within these devices, or any other suitable processing device. In general, the endpoint 150 and its components may be adapted to execute any operating system. In some instances, the endpoint 150 may be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the endpoint 150. Such information may include digital data, visual information, or a GUI 156, as shown with respect to the endpoint 150. Specifically, the endpoint 150 may be any computing device operable to communicate with the anomaly detection engine 102, other end point(s), and/or other components via network 140, as well as with the network 140 itself, using a wireline or wireless connection. In general, the endpoint 150 comprises an electronic computer device operable to receive, transmit, process, and store any appropriate data associated with the environment 100 of FIG. 1.

The client application 158 executing on the endpoint 150 may include any suitable application, program, mobile app, or other component. Client application 158 can interact with the anomaly detection engine 102, or portions thereof, via network 140. In some instances, the client application 158 can be a web browser, where the functionality of the client application 158 can be realized using a web application or website that the user can access and interact with via the client application 158. In other instances, the client application 158 can be a remote agent, component, or a dedicated application associated with the anomaly detection engine 102. In some instances, the client application 158 can interact directly or indirectly (e.g., via a proxy server or device) with the anomaly detection engine 102 or portions thereof.

GUI 156 of the endpoint 150 interfaces with at least a portion of the environment 100 for any suitable purpose, including generating a visual representation of any particular client application 158 and/or the content associated with any components of the anomaly detection engine 102. For example, the GUI 156 can be used to present screens and information associated with the machine learning engine 108 and interactions associated therewith. GUI 156 may also be used to view and interact with various web pages, applications, and web services located local or external to the endpoint 150. Generally, the GUI 156 provides the user with an efficient and user-friendly presentation of data provided by or communicated within the system. The GUI 156 may comprise a plurality of customizable frames or views having interactive fields, pull-down lists, and buttons operated by the user. In general, the GUI 156 is often configurable, supports a combination of tables and graphs (bar, line, pie, status dials, etc.), and is able to build real-time portals, application windows, and presentations. Therefore, the GUI 156 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software may instead include a number of sub-components, third-party services, libraries, and such, as appropriate. Conversely, the features and functionality of various components can be combined into single components as appropriate.

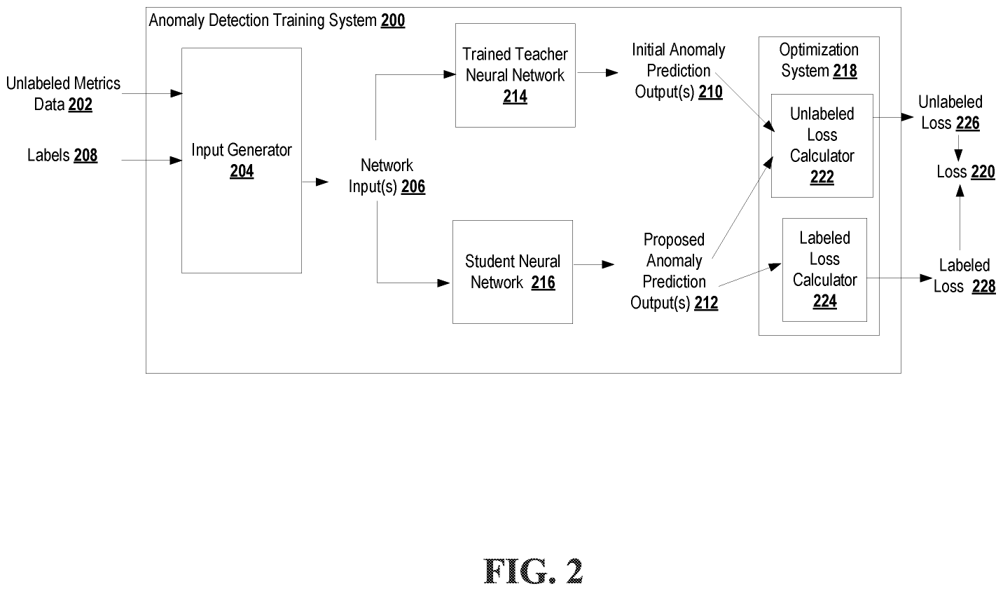

FIG. 2 shows an example anomaly detection training system 200 that is configured to train a machine learning model to perform anomaly detection in a networked environment, such as the networked environment 100.

As illustrated in FIG. 2, the anomaly detection training system 200 includes an input generator 204, a trained teacher neural network 214, a student neural network 216, and optimization system 218.

The input generator 204 processes a set of unlabeled metrics data 202 and a set of respective labels 208 to generate a set of network inputs 206. The generator 204 can modify the set of unlabeled metrics data 202 and the respective labels 208 to conform to a format that can be processed by a neural network e.g., a vector or a matrix.

The set of unlabeled metrics data 202 relates to a set of accounts. In some examples, the accounts are financial accounts e.g., investment accounts, wealth management accounts, transactional accounts, privately managed portfolios, etc. The unlabeled metrics data 202 can include, for example, conflict of interest data, privacy impact assessment metrics, code of regulations metrics, and customer details.

The set of respective labels 208 are associated with a first set of unlabeled metrics data. The first set of unlabeled metrics data is a subset of the set of unlabeled metrics data 202. Each label in the set of respective labels 208 is associated with an account in the set of accounts. The labels can identify whether the account includes an anomaly or does not include an anomaly e.g., the labels can read “Anomaly” or “Not Anomaly” (or can be presented digitally, e.g., using a 0 or 1). An anomaly is any unexpected behavior that deviates from normal behavior and in the context of particular types of accounts, such anomalies or anomalous behaviors can include, e.g., fraudulent activities including unusually high spending, mis-selling, and rogue trading.

Each network input in the set of network inputs 206 can represent an account in the set of accounts. Each network input can characterize data regarding a particular account. The input generator 204 process both the first set of unlabeled metrics data that is associated with the set of respective labels 208 and a second set of unlabeled metrics data that is not associated with the respective labels to generate the set of network inputs. Because of this, some network inputs are associated with a label while other network inputs are not associated with a label.

The trained teacher neural network 214 is configured to process the set of network inputs that are not associated with a label to generate a respective initial anomaly prediction output 210 for each network input. The trained teacher neural network 214 can be any appropriate type of neural network that implements an anomaly detection algorithm e.g., Isolation Forest, Support vector machines, k-nearest neighbors etc. In some examples, the initial anomaly prediction output 210 for each network input can be a predicted label e.g., “Anomaly” or “Not Anomaly” (or a corresponding digital representation, e.g., 0 or 1). In other examples, the initial anomaly prediction output can be a likelihood (e.g., a value ranging between 0.0 and 1.0) that there is an anomaly in the account associated with the network input.

The trained teacher neural network 214 is initially trained using unsupervised learning techniques for an initial training iteration. Once the teacher neural network 214 has been trained, it serves as a teacher model in a student-teacher machine learning framework with the student neural network 216. Each output student model from an Nth training iteration, where N is an integer greater than or equal to 1, is the teacher model for the N+1th training iteration in the student-teacher machine learning framework.

The student neural network 216 is configured to process the set of network inputs that are associated with a label and that are not associated with a label to generate a respective proposed anomaly prediction output 212 for each network input. The student neural network 214 can be any appropriate type of neural network that implements an anomaly detection algorithm e.g., Isolation Forest, Support vector machines, k-nearest neighbors etc. In some examples, the proposed anomaly prediction output 212 for each network input can be a predicted label e.g., “Anomaly” or “Not Anomaly”. In other examples, the proposed anomaly prediction output can be a likelihood that there is an anomaly in the account associated with the network input.

In some examples, the student neural network 214 and the trained teacher neural network 216 can have a same architecture and implement the same anomaly detection algorithm. For example, the trained teacher neural network 214 and the student neural network 216 can implement an Isolation Forest anomaly detection algorithm. An Isolation Forest anomaly detection algorithm uses binary trees to detect anomalies. Using an Isolation Forest anomaly detection algorithm allows for the capacity to scale easily to handle large data sizes. In some examples, the student neural network 216 and the trained teacher neural network 214 can implement an Extended Isolation Forest algorithm. Extended Isolation Forest Algorithms can separate anomalous regions and non-anomalous regions more clearly than conventional Isolation Forest algorithms. Basic Isolation Forest algorithms cut decision boundaries with only horizontal and vertical slopes and may identify anomalous regions where data does not exist. Extended Isolation Forest algorithms allow the branching process to branch in every direction and does not suffer from overidentification of anomalous regions.

The optimization system 218 processes, for each account in the set of accounts, the initial anomaly prediction output 210 from the trained teacher neural network 214 and the proposed anomaly prediction output 212 from the student neural network 216 to optimize a loss 220. The student neural network 216 is trained using both unlabeled and labeled data. For a particular account, a network input can represent an account that is associated with a label from the set of respective labels 208 and the network input can represent labeled training data. The network input can also represent an account that is not associated with a label from the set of respective labels 208 and the network input can represent unlabeled training data. The student neural network 216 can be trained on the unlabeled training data using unsupervised learning techniques. The optimization system 218 includes a labeled loss calculator 222 and an unlabeled loss calculator 224. The optimization system 218 minimizes a loss term that measures a difference between the initial anomaly prediction output of the teacher neural network and the proposed anomaly prediction output of the student neural network when the set of respective labels 208 does not include a label associated with the account. The unlabeled loss calculator calculates an unlabeled loss 226. The unlabeled loss 226 can be, for example, a mean-squared error loss. The student neural network 216 can also be trained on the labeled data using supervised learning techniques. The optimization system 218 minimizes a loss term that measures a difference between the proposed anomaly prediction output of the student neural network and the label associated with the account when the set of respective labels includes a label associated with the account. The labelled loss calculator 224 calculates an labeled loss 228. The unlabeled loss 228 can be, for example, a cross entropy loss. The loss 220 can be a loss function that includes both loss terms. The loss 220 can be a weighted sum of the unlabeled loss 226 and the labeled loss 228. Training the student neural network 216 on a some labeled data enhances the unsupervised training techniques to result in a semi-supervised learning technique. For network inputs without labels, the student neural network 216 tries to mimic the teacher neural network 214. For network inputs with labels, the student neural network 214 learns the relationship between the data and the labels.

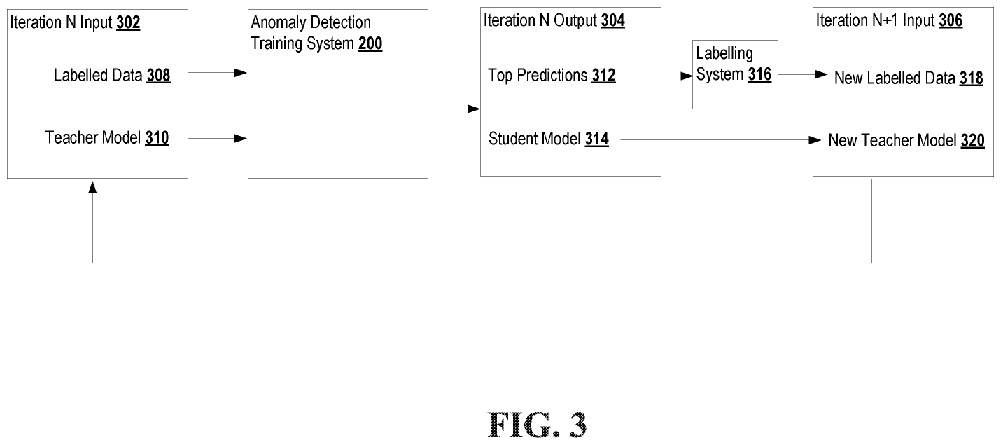

FIG. 3 shows an example of training a machine learning model to perform anomaly detection.

As shown in FIG. 3, for an Nth iteration in a series of training iterations (where Nis an integer greater than or equal to 1) an anomaly detection training system 200 receives a Nth iteration input 302 that includes labelled data 308 and a teacher model 310. The teacher model 310 is from a previous training iteration.

The anomaly detection training system 200 outputs a Nth training iteration output 304 that includes a set of top predictions 312 and a student model 314. The student model 314 is trained to perform anomaly detection and generate proposed anomaly detection outputs. After evaluating the accuracy of proposed anomaly detection outputs from the student neural network from the Nth training iteration, the anomaly detection training system 200 can generate a top subset of proposed anomaly detection outputs.

The labelling system 316 labels the top predictions 312 from the Nth training iteration output. The labelling system can actively query one or more human experts to label the top subset of proposed anomaly detection outputs. The human experts can also provide an explanation behind each label. The explanation can include an identification of particular anomalies in the account. The explanation can also include a ranking of anomalies in the account. The top subset of anomaly detection outputs can include the top K predictions made by the previous training iteration, where K is an integer greater than or equal to 1 e.g., 1000. The top predictions can be determined as the K predictions with the highest likelihood of an account being anomalous. In this example, the teacher model 310 and the student model 314 have a same architecture.

The student model 314 from the Nth training iteration is used as the new teacher model 320 in the N+1th training iteration input 306. The new labelled data 318 for the N+1th training iteration input 306 is the top predictions 312 from the Nth training iteration after they have been labelled.

Additional training iterations can be performed until a certain threshold is met. In some examples, the threshold can be a number of iterations e.g., 10, 100, 1000, 10000 etc. In other examples, the threshold can be a performance metric on test data e.g., 90% accuracy, 95% accuracy etc.

Because the teacher model for each iteration is a student model from a previous iteration, each student model improves upon the teacher model from the previous iteration by learning from a set of new labelled data. The student model can adapt to new data that it has not seen before and learn adaptively. The teacher model causes the anomaly detection system to exploit data that it has seen before while the student model causes the anomaly detection system to explore examples that it has not seen before.

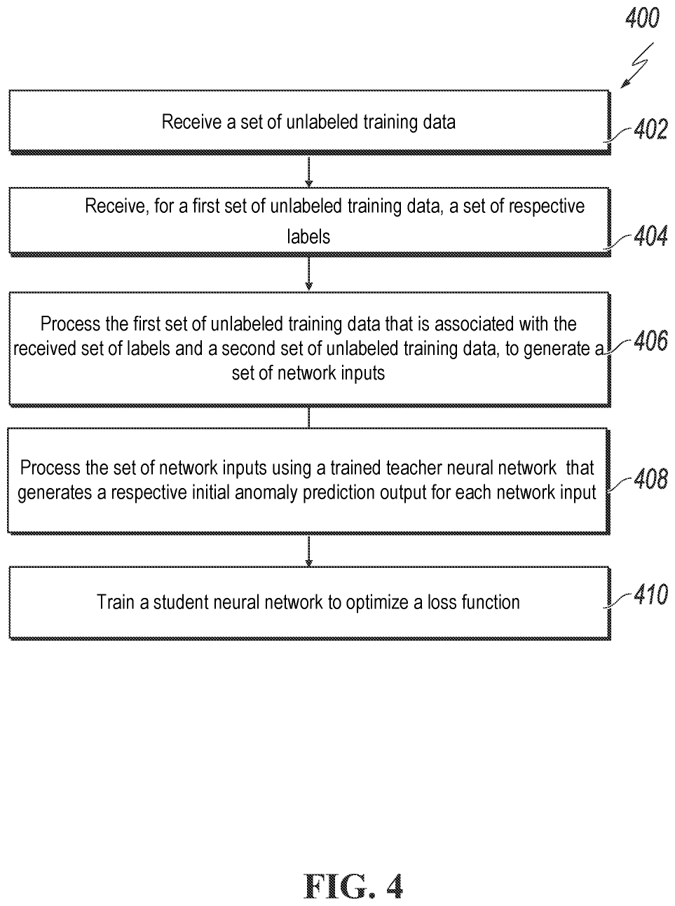

FIG. 4 is a flow diagram of an example method 400 for training an anomaly detection model. It should be understood that method 400 may be performed, for example, by any suitable system, environment, software, and hardware, or a combination of systems, environments, software, and hardware as appropriate. Any suitable system(s), architecture(s), or application(s) can be used to perform the illustrated operations. For convenience, the process 400 will be described as being performed by a training system.

At 402, the training system can utilize one or more data sources to obtain (e.g., over a network interface) metrics data relating to the set of accounts (or another digital asset, as applicable). The metrics data can include user details, conflict of interest data, account history, privacy data, user guidelines, among other types of metrics data. I

At 404, the training system can receive, for a first set of unlabeled metrics data, a set of respective labels. Each label is associated with an account in the set of accounts. The labels can be ground-truth indications that the account includes an anomaly or does not include an anomaly. The labels can be obtained from human experts. The training data for each account can correspond to a label that indicates whether the account includes an anomaly.

At 406, the training system can process the first set of unlabeled metrics data that is associated with the received set of labels and a second set of unlabeled metrics data, to generate a set of network inputs. Each network input can represent an account in the set of accounts.

At 408, the training system can process the set of network inputs using a trained teacher neural network that generates a respective initial anomaly prediction output for each network input. The trained teacher neural network allows the anomaly detection model to explore inputs regarding accounts that the model has not seen before.

At 410, the training system trains a student neural network to optimize a loss function. The student neural network can process the set of network inputs and generate a respective proposed anomaly prediction output for each network input. In some examples, the teacher neural network and the student neural network have the same architecture. The student neural network exploits inputs regarding accounts that it has seen before.

Optimizing the loss function can include, for each account in the set of accounts, minimizing a loss term that measures a difference between the initial anomaly prediction output of the teacher neural network and the proposed anomaly prediction output of the student neural network when the set of respective labels does not include a label associated with the account. The loss term can be a mean squared error.

Optimizing the loss function can further include, for each account in the set of accounts, minimizing a loss term that measures a difference between the proposed anomaly prediction output of the student neural network and the label associated with the account when the set of respective labels includes a label associated with the account. The loss term can be a cross entropy loss.

The loss term that measures a difference between the initial anomaly prediction output of the teacher neural network and a proposed anomaly prediction output of the student neural network can be represented as [symbol] ᵤ and the loss term that measures a difference between the proposed anomaly prediction output of the student neural network and the label associated with the account can be represented as [symbol] ₛ. The loss function can be:

w [symbol] ᵤ+ [symbol] ₛ,
where w is a weight term.

In some implementations, the training system can identify features that contribute to detection of an anomaly. The training system can extract a feature importance identification and include the feature importance identification in the proposed anomaly detection output and initial anomaly detection output. For example, the initial and proposed anomaly detection outputs can include a ranking of potentially anomalous features for a particular account. The training system can use SHAP values to extract the feature importance identification.

Additional training iterations can be performed until a certain threshold is met. In some examples, the threshold can be a number of iterations e.g., 10, 100, 1000, 10000 etc. In other examples, the threshold can be a performance metric on test data e.g., 90% accuracy, 95% accuracy etc.

The last student model at the last training iteration serves as the model for inference purposes. The inference model can accept an input of metrics data regarding an account and generate an anomaly detection output. The anomaly detection output can flag an anomaly in the account. The anomaly detection output can also identify features that contribute to detection of an anomaly. The anomaly detection output can also include an explanation of why an account is anomalous e.g., identify specific anomalies in an account.

When the inference model detects an anomaly, the anomaly can be acted on automatically or can be used to trigger an action by an investigative process. The action can include, for example, restricting access to the account, deleting the account, or requiring approval for any actions made regarding the account.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for training an anomaly detection model, comprising, for each training iteration in a series of training iterations:
receiving unlabeled metrics data relating to a set of accounts;
receiving, for a first set of unlabeled metrics data, a set of respective labels, wherein each label is associated with an account in the set of accounts;
processing (1) the first set of unlabeled metrics data that is associated with the received set of labels and (2) a second set of unlabeled metrics data, to generate a set of network inputs, wherein each network input represents a respective account in the set of accounts;
processing a subset of network inputs that correspond to the second set of unlabeled metrics data using a trained teacher neural network that generates a respective initial anomaly prediction output for each network input;
training a student neural network to optimize a loss function, wherein the student neural network processes the set of network inputs and generates a respective proposed anomaly prediction output for each network input, and wherein optimizing the loss function comprises, for each account in the set of accounts:
minimizing a loss term that measures a difference between the initial anomaly prediction output of the teacher neural network and the proposed anomaly prediction output of the student neural network when the set of respective labels does not include a label associated with the account; and
minimizing a loss term that measures a difference between the proposed anomaly prediction output of the student neural network and the label associated with the account when the set of respective labels includes a label associated with the account.

2. The computer-implemented method of claim 1, wherein the student neural network and the teacher neural network have a same architecture.

3. The computer-implemented method of claim 2, wherein the trained teacher neural network in a particular training iteration is the student neural network from a training iteration prior to the particular training iteration.

4. The computer-implemented method of claim 2, wherein receiving the set of respective labels associated with a subset of the set of metrics data representing the set of accounts comprises:
evaluating the accuracy of proposed anomaly detection outputs from the student neural network from a previous training iteration to generate a top subset of proposed anomaly detection outputs; and
actively querying human experts to label the top subset of proposed anomaly detection outputs.

5. The computer implemented method of claim 1, wherein the loss term that measures a difference between the initial anomaly prediction output of the teacher neural network and the proposed anomaly prediction output of the student neural network is a mean squared error.

6. The computer-implemented method of claim 1, wherein the loss term that measures a difference between the proposed anomaly prediction output of the student neural network and the label associated with the account is a cross-entropy loss.

7. The computer-implemented method of claim 1, wherein the teacher neural network implements an Isolation Forest anomaly detection algorithm.

8. A system comprising:
at least one memory storing instructions; and
at least one hardware processor interoperably coupled with the at least one memory, wherein execution of the instructions by the at least one hardware processor causes performance of operations comprising, for each training iteration in a series of training iterations:
receiving unlabeled metrics data relating to a set of accounts;
receiving, for a first set of unlabeled metrics data, a set of respective labels, wherein each label is associated with an account in the set of accounts;
processing (1) the first set of unlabeled metrics data that is associated with the received set of labels and (2) a second set of unlabeled metrics data, to generate a set of network inputs, wherein each network input represents a respective account in the set of accounts;
processing the set of network inputs using a trained teacher neural network that generates a respective initial anomaly prediction output for each network input;
training a student neural network to optimize a loss function, wherein the student neural network processes the set of network inputs and generates a respective proposed anomaly prediction output for each network input, and wherein optimizing the loss function comprises, for each account in the set of accounts:
minimizing a loss term that measures a difference between the initial anomaly prediction output of the teacher neural network and the proposed anomaly prediction output of the student neural network when the set of respective labels does not include a label associated with the account; and
minimizing a loss term that measures a difference between the proposed anomaly prediction output of the student neural network and the label associated with the account when the set of respective labels includes a label associated with the account.

9. The system of claim 8, wherein the student neural network and the teacher neural network have a same architecture.

10. The system of claim 9, wherein the trained teacher neural network in a particular training iteration is the student neural network from a training iteration prior to the particular training iteration.

11. The system of claim 9, wherein receiving the set of respective labels associated with a subset of the set of metrics data representing the set of accounts comprises:
evaluating the accuracy of proposed anomaly detection outputs from the student neural network from a previous training iteration to generate a top subset of proposed anomaly detection outputs; and
actively querying human experts to label the top subset of proposed anomaly detection outputs.

12. The system of claim 8, wherein the loss term that measures a difference between the initial anomaly prediction output of the teacher neural network and the proposed anomaly prediction output of the student neural network is a mean squared error.

13. The system of claim 8, wherein the loss term that measures a difference between the proposed anomaly prediction output of the student neural network and the label associated with the account is a cross-entropy loss.

14. A non-transitory, computer-readable medium storing computer-readable instructions, that upon execution by at least one hardware processor, cause performance of operations, comprising for each training iteration in a series of training iterations:
receiving unlabeled metrics data relating to a set of accounts;
receiving, for a first set of unlabeled metrics data, a set of respective labels, wherein each label is associated with an account in the set of accounts;
processing (1) the first set of unlabeled metrics data that is associated with the received set of labels and (2) a second set of unlabeled metrics data, to generate a set of network inputs, wherein each network input represents a respective account in the set of accounts;
processing the set of network inputs using a trained teacher neural network that generates a respective initial anomaly prediction output for each network input;
training a student neural network to optimize a loss function, wherein the student neural network processes the set of network inputs and generates a respective proposed anomaly prediction output for each network input, and wherein optimizing the loss function comprises, for each account in the set of accounts:
minimizing a loss term that measures a difference between the initial anomaly prediction output of the teacher neural network and the proposed anomaly prediction output of the student neural network when the set of respective labels does not include a label associated with the account; and
minimizing a loss term that measures a difference between the proposed anomaly prediction output of the student neural network and the label associated with the account when the set of respective labels includes a label associated with the account.

15. The non-transitory, computer-readable medium of claim 14, wherein the student neural network and the teacher neural network have a same architecture.

16. The non-transitory, computer-readable medium of claim 15, wherein the trained teacher neural network in a particular training iteration is the student neural network from a training iteration prior to the particular training iteration.

17. The non-transitory, computer-readable medium of claim 15, wherein receiving the set of respective labels associated with a subset of the set of metrics data representing the set of accounts comprises:
evaluating the accuracy of proposed anomaly detection outputs from the student neural network from a previous training iteration to generate a top subset of proposed anomaly detection outputs; and
actively querying human experts to label the top subset of proposed anomaly detection outputs.

18. The non-transitory, computer-readable medium of claim 14, wherein the loss term that measures a difference between the initial anomaly prediction output of the teacher neural network and the proposed anomaly prediction output of the student neural network is a mean squared error.

19. The non-transitory, computer-readable medium of claim 14, wherein the loss term that measures a difference between the proposed anomaly prediction output of the student neural network and the label associated with the account is a cross-entropy loss.
